(19) United States
(12) Patent Application Publication
(10) Pub. No.: US 2024/0069963 A1
(43) Pub. Date: Feb. 29, 2024

(54) Goal Oriented Intelligent Scheduling System

(71) Applicant: Mindbody, Inc., San Luis Obispo, CA (US)

(72) Inventors: Zaid Gharaybeh, La Jolla, CA (US); Yulia O. Hendrix, Boise, ID (US); Scott Knox, San Diego, CA (US); Steven J. Bryden, Paso Robles, CA (US); Kanaka Prasad Saripalli, Danville, CA (US); LaDell A. Erby, San Luis Obispo, CA (US)

(73) Assignee: Mindbody, Inc., San Luis Obispo, CA (US)

(21) Appl. No.: 17/900,423

(22) Filed: Aug. 31, 2022

(51) Int. Cl. G06F 9/48; G06N 3/04; G06N 3/08

(52) U.S. Cl. CPC G06F 9/4881; G06N 3/0445; G06N 3/08

(57) ABSTRACT

A system includes an orchestration engine. The orchestration engine is configured to receive communications from a client device of a client and a provider device of a provider. The orchestration engine is configured to execute workflows across a plurality of artificial intelligence engines. The plurality of artificial intelligence engines includes a first set of artificial intelligence engines, a second set of artificial intelligence engines, and a third set of artificial intelligence engines.

### FIELD OF THE DISCLOSURE

Embodiments disclosed herein generally relate to a system and method for intelligently generating an optimized goal-oriented schedule using artificial intelligence concierge agents.

### BACKGROUND

Scheduling software assists multiple stakeholders across businesses by managing their resources and deliverables efficiently and effectively. Scheduling is a key need in many businesses and service verticals, such as healthcare, transportation, hospitality, wellness, finance, and general administration. Suboptimal schedules and scheduling practices are known to contribute to significant inefficiencies and resource and revenue loss. For example, much time may be lost to commuting for contractors such as electricians, plumbers, and personal trainers, depending on the specific scheduled sequence of locations they must travel to for each service. In another example, a planned event, such as an outdoors yoga class, may yield many more attendees/much more demand and revenue, depending on the specific date and time for which it is scheduled. Scheduling inefficiencies amount to billions of dollars of lost revenue across industries.

### SUMMARY

In some embodiments, a system is disclosed herein. The system includes an orchestration engine. The orchestration engine is configured to receive communications from a client device of a client and a provider device of a provider. The orchestration engine is configured to execute workflows across a plurality of artificial intelligence engines. The plurality of artificial intelligence engines includes a first set of artificial intelligence engines, a second set of artificial intelligence engines, and a third set of artificial intelligence engines. The first set of artificial intelligence engines is configured to work in conjunction to execute a booking workflow for processing a booking request received from the client device or the provider device. The second set of artificial intelligence engines is configured to work in conjunction to execute a rebooking workflow for processing a rebooking request received upon detecting a first trigger event. The third set of artificial intelligence engines is configured to work in conjunction to execute an event filling workflow to optimize a schedule of the provider.

In some embodiments, a method is disclosed herein. A computing system receives a request to schedule an appointment for a client. The appointment is for a service with a service provider. A deep reinforcement learning network of the computing system, generates a set of recommend times for the service. The set of recommend times minimizes fragmentation in a schedule of the service provider. The computing system causes the set of recommended times to be displayed to the client. Responsive to receiving a selection from the client, the computing system generates an appointment event for the client.

In some embodiments, a method is disclosed herein. A computing system detects a trigger event to execute a workflow to fill an open appointment with a provider. Responsive to detecting the trigger event, a recurrent neural network generates a list of clients for the open appointment based on constraints of a service being offered at the open appointment and historical booking information associated with the list of clients. For each client in the list of clients, the computing system using a generative adversarial network, generates a customized communication. The computing system determines, using contextual bandwidth algorithms, a frequency at which to send each customized communication. An online machine learning model of the computing system identifies a best time of day to deliver the customized communication to each client in the list of clients based on a context of the customized communication. The computing system sends each customized communication.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating scheduling system in more detail, according to example embodiments.

FIG. 3 is a block diagram illustrating exemplary booking workflows, according to example embodiments.

FIG. 4 is a block diagram illustrating an example rebooking workflow, according to example embodiments.

FIG. 5 illustrates an example graphical user interface (GUI), according to example embodiments.

FIG. 6 is a block diagram visually illustrating processes performed by attendance cadence estimator, according to example embodiments.

FIG. 7 is a block diagram illustrating an example event fill workflow, according to example embodiments.

FIG. 8A illustrates a system bus computing system architecture, according to example embodiments.

FIG. 8B illustrates a computer system having a chipset architecture, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Scheduling software performs key functions for businesses, such as customer scheduling, staff scheduling, automatic reminders, and calendar management. Scheduling software also typically includes real-time automated engines for these functions. Conventional scheduling software, however, while providing clients with appointment and event scheduling functionality, are limited in their abilities to optimize and automate scheduling, especially in multi-stakeholder environments.

To account for such limitations, one or more techniques described herein provide one or more artificial intelligence and deep learning techniques, which can be embodied as one or more cooperating concierge artificial intelligence agents, to optimize and automate the various scheduling flows across multiple organizational boundaries, thus satisfying the unique goals and requirements of the multiple stakeholders involved. Such techniques may be applicable to a broad range of businesses, due to the forementioned scheduling problems and being very similar across different industries (e.g., transportation, healthcare, wellness, delivery services, etc.).

The term “user” as used herein includes, for example, a person or entity that owns a computing device or wireless device; a person or entity that operates or utilizes a computing device; or a person or entity that is otherwise associated with a computing device or wireless device. It is contemplated that the term “user” is not intended to be limiting and may include various examples beyond those described.

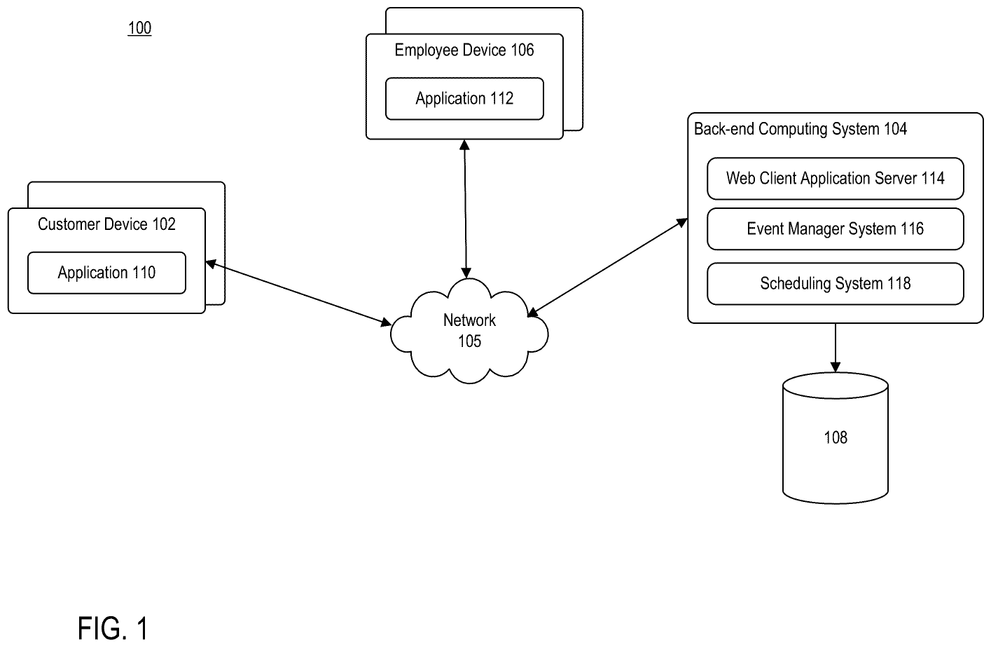

FIG. 1 is a block diagram illustrating a computing environment 100, according to one embodiment. Computing environment 100 may include at least a customer device 102, a back-end computing system 104, and a service provider system 106 communicating via network 105.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receiving information between the components of computing environment 100.

Customer device 102 may be operated by a user or customer. Exemplary customers may include, but are not limited to, customers seeking an appointment with one of the one or more service provider systems 106. In some embodiments, customer device 102 may be representative of one or more computing devices, such as, but not limited to, a mobile device, a tablet, a personal computer, a laptop, a desktop computer, or, more generally, any computing device or system having the capabilities described herein.

Customer device 102 may include application 110. Application 110 may be associated with back-end computing system 104 through which a user may schedule an appointment or manage their appointment(s) with a service provider system 106. In some embodiments, application 110 may be a standalone application associated with back-end computing system 104. In some embodiments, application 110 may be representative of a web-browser configured to communicate with back-end computing system 104. For example, customer device 102 may be configured to execute application 110 to access a portal provided by back-end computing system 104 for the user to request an appointment with a service provider system 106. The content that is displayed to the user via customer device 102 may be transmitted from web client application server 114 of back-end computing system 104 to customer device 102, and subsequently processed by application 110 for display through a graphical user interface (GUI).

One or more service provider systems 106 may be representative of one or more service providers that utilize scheduling functionality of back-end computing system 104. Exemplary service providers may include, but are not limited to, transportation service providers, healthcare service providers, wellness service providers, delivery service providers, and the like. In some embodiments, one or more service provider systems 106 may be representative of one or more computing devices, such as, but not limited to, a mobile device, a tablet, a personal computer, a laptop, a desktop computer, or, more generally, any computing device or system having the capabilities described herein.

Service provider systems 106 may include application 112. Application 112 may be associated with back-end computing system 104 through which an employee or user associated with a service provider may manage or optimize their appointment schedule with customers. In some embodiments, application 112 may be a standalone application associated with back-end computing system 104. In some embodiments, application 112 may be representative of a web-browser configured to communicate with back-end computing system 104. For example, service provider systems 106 may be configured to execute application 112 to access a portal provided by back-end computing system 104 for the user to view their upcoming appointments. In some embodiments, provider systems 106 can execute application 112 such that a user can optimize the service provider's scheduling across customers. The content that is displayed to the user via service provider system 106 may be transmitted from web client application server 114 of back-end computing system 104 to service provider system 106, and subsequently processed by application 112 for display through a graphical user interface (GUI).

Back-end computing system 104 may be configured to communicate with one or more customer devices 102 and/or one or more service provider systems 106. As shown, back-end computing system 104 may include a web client application server 114, event manager system 116, and scheduling system 118.

Each of event manager system 116 and scheduling system 118 may be comprised one or more software modules. The one or more software modules are collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Event manager system 116 may be configured to create one or more event objects. An event object is a core component of scheduling. An event object may represent a block of time during which one or more resources may be in use. An event may have one or more resources associated with it, such as a specific service provider, room, or piece of equipment. Those resources may be used for the entire duration of the event, for a subset of the event duration, or for multiple subset time ranges within the event duration. For example, a service provider may apply foils at the beginning of a hair appointment, and then have the customer occupy a dryer chair in the middle, while the service provider is free to do other things, and then move the customer out of the dryer chair at the end of the appointment to remove the foils. This variety of resources is referred to as the resource allocation within an event.

There may be different types of events, based on the event purpose, such as appointment, class, blocked times (e.g., employee lunch, personal appointment, outside of working hours, etc.), cleanup, travel, preparation work, administrative tasks, and the like. These different types of events may indicate whether the event has other characteristics, such as, but not limited to, whether the event has a service associated with it, whether the event's existence depends on customers being present, and whether the exact number of attendees or revenue generated from the event is known ahead of time. If, for example, there is a service associated with the event, there may be many additional attributes of the service that could impact the scheduling of that service for an event. Some examples of attributes may include, but are not limited to, even capacity (e.g., the number of people an event for that service can accommodate) and the default length of time of an event for this service. In some embodiments, resources may also have attributes that impact scheduling, such as whether a resource is allowed to be double-booked, whether the resource requires preparation time before and/or after the event, whether the resource is being assigned to multiple events that overlap, or whether the resource is assigned to multiple providers at the same time.

One specific service attribute is the resource requirement. In some embodiments, for event manager system 116 to create an event, event manager system 116 may first be required to satisfy a resource requirement for the event. For example, a single resource requirement may include a resource type and the number of resources for that type. The resource requirements may have a priority order, such that if one resource type is unavailable, another resource type may be used as a substitution. For example, a sports program drill class may require the space of either a single tennis court or two badminton courts. In order to accommodate resource allocation, event manager system 116 may employ prioritization and substitution resource tags. Such tags may provide service providers with the flexibility to share resources across services as opposed to designating specific unique resources for each service.

Tags may enable a more flexible setup for scheduling through resource allocation, eligibility, availability, and reporting. Tags may enable configurations to be applied to groups of entities as well as individual entities and can be both user-generated and system-generated. For example, a tag may be defined at any level of a business or franchise, and propagated down, such that consistent resource configurations may be available throughout the business.

To further enable the flexible and efficient configuration and management of multiple reoccurring events, event manager system 116 may employ event templates. Event templates may be configured by the user and automatically applied to all events that satisfy or fit the configuration of the event template. In some embodiments, an event template may include properties, such as, but not limited to, a start and an end time of the event, duration, day(s) of the week, the cadence at which to create events (e.g., daily, weekly, bi-weekly, monthly, etc.), which service or services are associated with the event, which resources are assigned to the event, and the start and end dates that the events created fall within. Event templates may be created at different levels within a business (e.g., a specific location, business, franchise, region, or grouping within the franchise, brand, or account). In some embodiments, the properties of the event template's properties can then be propagated to events created at specific locations (lowest level). This allows higher-level managers within a large business to autonomously, flexibly, consistently, and efficiently manage the schedules, resources, and services of many entities at varying levels under them.

In some embodiments, templates can be expanded to past events and event schedules and applied to resource availability using tags. Tags may be used to specify which resources are available to be used for certain services. In some embodiments, any number of individual resources can be assigned the same tag. For example, specific yoga instructors can teach beginner yoga class. Accordingly, the tag—“yoga instructor”—can thus be used as a tag to indicate a specific set of skills plus satisfy the resource requirement for a beginner yoga class. The same tag may be used to identify other resources with similar properties and configurations. For example, when hiring a new instructor, the “yoga instructor” tag would allow event manager system 116 or scheduling system 118 to reuse existing schedule configuration information instead of creating such information from scratch for each new hire. Thus, a resource's eligibility can also be viewed as a template that is easily assigned or removed from any resources.

Another extension of the concept of templates beyond the application of event templates is that various entities could be configured at a higher franchise level and utilized at lower levels of the business. For example, a service could be created at the brand level, with a name, description, type (e. g. class vs. appointment), default capacity, default duration, default room layout, and tags, and then that service could be propagated down to individual business locations. This enables the same services to be offered and configured in the same way at all locations of a franchise without needing a new set up at every single location of that franchise. In this manner, tags created at a higher level may be propagated down so that every level of the organization may use the same categorization, configuration, and terminology.

In some embodiments, event manager system 116 may identify when and where an event template is used. In this manner, event manager system 116 may create a reference of where, in the organization hierarchy, the event template was created. Such monitoring allows event manager system 116 to handle modifications to the event template at each level, and even propagate those modifications downwards. For example, the same service may exist at all locations within a franchise, but the Pacific North-West region may include additional legal information in its description and additional tags to apply compared locations in the Midwest region of the franchise. In this case, event manager system 116 can still create the event template at the highest level of the franchise, propagate the event template down to services at each region, and then propagate the event template down to services at each business and each location under that. If, for example, the event template that is created is modified for the Pacific North-West region to include a different description and additional tags, event manager system 116 can propagate that change down through every level below, leaving the service definitions at the locations in the Midwest unaffected.

When a customer attends an event, either class-based or appointment-based event, event manager system 116 may create a reservation and an itinerary for the event. In some embodiments, an itinerary may include of one or more events (e.g., when multiple services are being performed back-to-back such as a manicure followed by a pedicure). In some embodiments, a reservation may also include of one or more itineraries (e.g., when a group of multiple people are all attending an event together, such as a bridal group getting manicures and pedicures).

In some embodiments, event creation may be dictated by the service type. For example, for appointment type services, an event may not exist without someone attending the appointment. The creation of an event for an appointment-based service may occur when a customer takes action to create the appointment (e.g., by calling the business or booking online). For class-type services, events for that service may exist, regardless of whether or not anyone is attending the event.

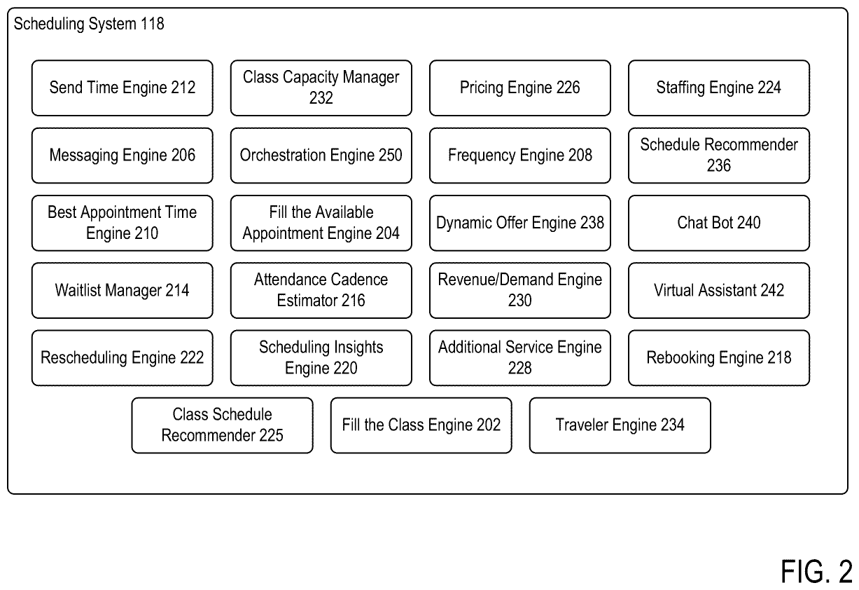

Scheduling system 118 may be configured to manage the scheduling of events for a service provider. For example, scheduling system 118 may be representative of a scheduling optimization and scheduling planning/tracking platform configured to automate and enhance scheduling for a service provider or organization. Scheduling system 118 is discussed in more detail below, in conjunction with FIG. 2.

In some embodiments, back-end computing system 104 may be in communication with database 108. As shown, database 108 may be configured to store information associated with service provider systems 106. For example, database 108 may be configured to store service information associated with each service provider. Example service information may include, but is not limited to, a number of services provided by the service provider, the days each service is provided, a length of time associated with the service, any dependencies to the service, and a cost of the service. In some embodiments, database 108 may be configured to store schedule information associated with each staff member of the service provider. In some embodiments, database 108 may be configured to store resource information associated with the services. As indicated above, back-end computing system 104 may utilize tags to specify which resources are available to be used for certain services. In some embodiments, database 108 may further be configured to store client information. For example, database 108 may store historical appointment information associated with each client.

FIG. 2 is a block diagram illustrating scheduling system 118 in more detail, according to example embodiments. As briefly indicated above, scheduling system 118 may be representative of a scheduling optimization, planning, and tracking platform. Scheduling system 118 may utilize a suite of artificial intelligence engines to intelligently automate and optimize a service provider's scheduling processes during various phases of the business lifecycle.

As shown, scheduling system 118 may include a plurality of modules. For example, scheduling system 118 may include one or more of fill the class engine 202, fill the available appointment engine 204, messaging engine 206, frequency engine 208, best appointment time engine 210, send time engine 212, waitlist manager 214, attendance cadence estimator 216, rebooking engine 218, scheduling insights engine 220, rescheduling engine 222, staffing engine 224, class schedule recommender 225, pricing engine 226, additional service recommendation engine 228, revenue/demand engine 230, class capacity manager 232, traveler engine 234, schedule recommender 236, dynamic offer engine 238, chat bot 240, virtual assistant 242, and orchestration engine 250. Each of fill the class engine 202, fill the available appointment engine 204, messaging engine 206, frequency engine 208, best appointment time engine 210, send time engine 212, waitlist manager 214, attendance cadence estimator 216, rebooking engine 218, scheduling insights engine 220, rescheduling engine 222, staffing engine 224, class schedule recommender 225, pricing engine 226, additional service recommendation engine 228, revenue/demand engine 230, class capacity manager 232, traveler engine 234, schedule recommender 236, dynamic offer engine 238, chat bot 240, virtual assistant 242, and orchestration engine 250. may be comprised of one or more software modules. The one or more software modules are collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Fill the class engine 202 may be configured to match customers with open spots in classes. For example, for a particular class session with vacancies, fill the class engine 202 may be configured to analyze the class information and historical attendance information to generate a list of customers who would most likely be interested in the service at the given date/time. The generated customer list may be used to generate automated notifications or message to notify a customer of the opening.

In some embodiments, fill the class engine 202 may include a recurrent neural network architecture (e.g., long short-term memory (LSTM) network) to identify those customers who are likely to fill a particular class spot by analyzing their historical booking patterns and predicting when they are likely to return. From the list of possible candidates, fill the class engine 202 may utilize a contextual bandits approach that prioritizes the order in which service provider system 106 should contact the customers in the list of customers in order to find the customer that would accept the offer with the minimal number of contact attempts. The contextual bandit algorithm may be representative of a generalization of the multi-armed bandit that considers contextual features associated with customers booking history when choosing an action. This approach assists service providers in learning which customers are most likely to accept an offer to take a class spot. In this manner, scheduling system 118 can quickly adapt to customers' evolving preferences.

Fill the available appointment engine 204 may be configured to extend the functionality of fill the class engine 202 by adding an additional task of choosing the best service, given all the resource constraints, to fill the empty timeslots in the staff schedules. Fill the available appointment engine 204 may be configured to identify an empty time slot and determine a list of service-client pairs for the empty time slot.

Fill the available appointment engine 204 may include two sub-modules: a customer-to-service recommender and a customer-to-time block recommender. Customer-to-service recommender may be configured to identify a customer that would be a good match for a given service, as well as identifying a service or services that would be a good match for the customer. Customer-to-time block recommender may be configured to identify a customer that would be a good match for a given appointment block, as well as, given a customer, identifying the appointment blocks that would be a good match.

In some embodiments, fill the available appointment engine 204 may take a recurrent neural network based approach (e.g., LSTM network) to analyze customers' historical booking pattern and generate a list of candidate customers that may be expected to book an appointment on the relevant day. Fill the available appointment engine 204 may then rank and/or sort the list of candidate customers. In some embodiments, fill the available appointment engine 204 may utilize a constraint optimization algorithm coupled with deep learning techniques to choose the service and a list of customers that are interested and/or due/overdue for this service, constrained by resource availability.

In some embodiments, fill the available appointment engine 204 may provide the recommendations the service provider (e.g., service provider system 106) as a list of potential services and a list of potential clients that might be interested in the services for that empty time slot. In some embodiments, fill the available appointment engine 204 may automatically send availability messages to clients (e.g., customer devices 102) to try to fill the empty time slot.

Messaging engine 206 may be configured to customize a communication to a current or potential customer. For example, messaging engine 206 may be configured to find the wording to use in a communication to a current or potential client, as well as the appropriate communication channel (e.g., email, text, app notification, etc.) that is most likely to succeed in the communication's goal. Messaging engine 206 may include a recommendation algorithm that is trained on historical messages and their interaction data to identify the most effective messaging with the highest expected engagement/response rate. The recommendation algorithm may provide a base message, from which messaging engine 206 may generate a personalized message tailored to the specific service/class that is being filled.

In some embodiments, messaging engine 206 may utilize a combination of a generative adversarial network coupled with a deep learning keyword extractor. Such combination assists in customizing the functionality of messaging engine 206 for a specific service provider. In some embodiments, deep learning keyword extractor may be configured to extract relevant information from the service and class description for inclusion in the base message. Such approach may help transform a base message into a personalized service-specific message that may maximize engagement.

Frequency engine 208 may be configured to identify the optimal communication frequency for each customer (e.g., customer device 102). As those skilled in the art understand, communicating with a customer (either potential, lapsed, or current) too often may drive the customer away; moreover, a lack of communication with the customer may lead to poor engagement or churn. To identify the optimal communication frequency for each customer, frequency engine 208 may utilize one or more contextual bandit algorithms to experiment with the frequency of messaging for each customer based on the customer's features and interactions (e.g., unsubscribe, clicks, etc.).

In some embodiments, frequency engine 208 may be configured to learn an optimal frequency for a customer by testing various actions (e.g., communication frequencies) and identifying the most effective action for a given customer. Available context may help the contextual bandit algorithms of frequency engine 208 to adapt to a changing environment. Exemplary contextual features may include, but are not limited to, geographical location, distance to service provider, time of day, day of week, weather, month, time of year, holidays, demographic information, prior visits, and interactions. In some embodiments, the available context may also assist with potential cold start problems, such as when not enough information may be available for an individual customer.

Best appointment time engine 210 may be configured to optimize revenue for a service provider by analyzing a service provider's schedule and suggesting times for customers to book. Small, unused, gaps in a service provider's schedule are typically identified as a top pain point for the service provider. These gaps, while individually small, can add up to hours of wasted availability over the course of a week, month, etc. Best appointment time engine 210 attempts to reduce the number of small, unused gaps by analyzing a service provider's schedule and appointment resource requirements and generating a list of start times based on a schedule's resource availability. Best appointment time engine 210 may list the start times based on how well those times prevent schedule defragmentation.

In some embodiments, best appointment time engine 210 may utilize deep reinforcement learning techniques. Generally, reinforcement learning is concerned with how an algorithm learns to act intelligently in an environment to maximize some notion of a reward. In the present case, the reward may be based on how fragmented a service provider's schedule is, with less fragmentation corresponding to a higher reward.

Based on the services offered by the service provider and the service provider's expected (predicted) demand, best appointment time engine 210 may utilize deep reinforcement learning techniques (e.g., actor-critic, advantage actor critic, deep Q-learning, etc.) to recommend times for each requested service that minimize schedule fragmentation. In some embodiments, best appointment time engine 210 may utilize a single algorithm that learns to act across many service providers.

In some embodiments, best appointment time engine 210 may be configured to utilize associative rule mining in addition to the one or more deep reinforcement learning techniques. Associative rule mining may be used to enhance schedule defragmentation by identifying booking patterns and generating start time recommendations that take into account services that are often booked together or most likely being booked on certain days and/or times. Generally, associative rule mining is a method of discovering relationships between items/occurrences in data sets. For example, in a data set of grocery store purchases, associative rule mining may be used to discover that when peanut butter and jelly are purchased items, bread is likely to also be in the basket. Best appointment time engine 210 may utilize this approach such that, given historical booking records associated with a service provider, best appointment time engine 210 may find the most common booking patterns based on service provider availability and the requested appointment's duration. In this manner, when a customer requests a booking, booking start times may be recommended based on the discovered patterns.

Send time engine 212 may be configured to identify the best time to deliver a communication to a customer by learning customer response patterns. In some embodiments, send time engine 212 may be trained to identify the best time of day to deliver a communication to the customer based on the context of the message. For example, send time engine 212 may learn that some customers respond well to offers when they are notified about them in the evenings and are, thus, more likely to book appointments.

Send time engine 212 may be configured to learn to optimize the send time for individual recipients, thus increasing the likelihood that the recipient or customer receives their email at a time when they are most likely to engage with the communication. Send time engine 212 may be trained using historical communication data to profile each potential recipient based on their engagement history. Send time engine 212 may learn the behaviors of each potential recipient to predict the most appropriate time to send future messages. Send time engine 212 may be continually updated or retrained to adapt to change in recipient behavior.

Send time engine 212 may include a send time optimization model based on contextual bandit with Thompson sampling, which is a type of online machine learning algorithm. Online machine learning algorithms are a subtype of machine learning algorithms in which the models are trained using streaming data. The model may learn data patterns and may be updated as data becomes available overtime. In comparison, conventional batch training approaches train a machine learning model on historic data all at once. Accordingly, send time engine 212 can learn a customer's habit by testing various send times compared to customer preferences.

Waitlist manager 214 may be configured to intelligently manage class waitlists. For example, waitlist manager 214 may intelligently manage class waitlists in a manner that prioritizes frequent customers, at-risk customers, new customers, etc. In some embodiments, waitlist manager 214 may use machine learning techniques to understand the status of everyone on the waitlist, their membership tier, their attendance history, and their historic waitlist interactions to suggest which clients should be prioritized on the waitlist. In some embodiments, the suggestion may be generated such that clients at risk of churning or new clients who can become full members are not shut out of events.

Waitlist manager 214 may use a deep reinforcement model to identify waitlist MVPs and maximizing waitlist value/reward (each event waitlist is an episode). For example, deep reinforcement model may be rewarded when MVPs, who are on the waitlist, are offered a spot and they take that spot. In some embodiments, the reward may be based on one or more of membership information, visit frequency, tenure, lifetime revenue, and the like. By providing a reinforcement mechanism through these rewards, deep reinforcement model may be trained to improve its selection of users from the waitlist. The deep reinforcement model may be configured to maximize the reward and minimize the cost associated with the final list of people that are taken off the waitlist and attend the event. The deep reinforcement model may be configured to prioritize selecting people from the waitlist who are most likely to attend the event and whose attendance is of high value to the business. The deep learning aspect of deep reinforcement learning model allows a decision-making agent to act based on unstructured data (without manually engineering features) with improved performance.

Attendance cadence estimator 216 may be configured to predict the number of days between service events. For example, attendance cadence estimator 216 may be configured to predict the number of days between service events for each customer based on service type and/or event time slot. In some embodiments, attendance cadence estimator 216 may include a recurrent neural network. The recurrent neural network may be trained to predict when a customer will be back for another appointment. In some embodiments, attendance cadence estimator 216 may use a logistic regression function to predict the probability of a customer booking an offered appointment or class spot. In some embodiments, the probability of the customer booking an offered appointment may be combined with a contextual bandits approach to prioritize the order of customers the service provider may contact, in order to find a customer to accept the offer with the minimal number of attempts.

Rebooking engine 218 may be configured to recommend the best time and day for a customer's next appointment. In some embodiments, rebooking engine 218 may be invoked responsive to a class or appointment being cancelled or rescheduled. In some embodiments, rebooking engine 218 may be invoked right after a customer's current appointment is finished to suggest the best times for the next visit. In some embodiments, rebooking engine 218 may further be configured to generate a list of clients that have stopped booking appointments at regular intervals. In some embodiments, rebooking engine 218 may attempt to reinstate the clients on the list of clients to regular appointment cadence.

Rebooking engine 218 may work by orchestrating process across a plurality of components, such as fill the appointment engine 204, best appointment time engine 210, and attendance cadence estimator 216. For example, when a customer finishes an appointment, rebooking engine 218 may be configured to simplify and optimize the flow of rebooking the customer for a next appointment. To perform such process, rebooking engine 218 may utilize cadence estimator 216 to identify the general timeframe in which the customer's next appointment is determined or predicted to occur. Best appointment time engine 210 may then identify the best time slot for both the customer and the business (e.g., maximizing revenue for the business) based on the predicted timeframe.

Scheduling insights engine 220 may be configured to generate intelligent insights into a service provider's schedules. Such insights may be used to help measure the outcome of schedule changes, identify inefficiencies, improve visibility into performance, and provide action plans. For example, scheduling insights engine 220 may be trained to forecast demand for services, revenue, schedule utilization, and other time series data. After forecasting, scheduling insights engine 220 may be further configured to recommend action plans, such as when is a good time to take time off or schedule a day for facility maintenance (e.g., low forecasted demand days).

In some embodiments, scheduling insights engine 220 may utilize a recurrent neural network, such as an LSTM network. The recurrent neural network may be used to model and predict business-specific and industry specific trends. In some embodiments, the recurrent neural network can also be used for time-series anomaly detection for surfacing important insights to the service provider, thus improving visibility into performance and for alerting the service provider of any unusual activities.

For example, in some embodiments, to forecast demand for a particular service, an LSTM network may be trained on historical time series data, such as historical attendance and/or purchases of services, as well as other features that include, but are not limited to, one or more of day of year, holidays, day of the week, time of the day, service provider information and any other relevant data that can help identify attendance patterns. In some embodiments, model agnostic techniques, such as Shapley values or local interpretable model-agnostic explanation (LIME), can be used to identify feature importance and their contribution to the predictions. Such features can be presented as insights to help explain fluctuations and discovered patterns.

In some embodiments, such as when an LSTM network is used, scheduling insights engine 220 may be configured to identify the contribution of different variables to the predictions. Such interpretable insights may be presented in natural language form to the service provider.

Rescheduling engine 222 may be configured to coordinate the complex task of moving an appointment on a calendar. Generally, event rescheduling may occur for a variety of reasons, such as improving the schedule, increasing availability for facilitating more bookings, etc. Rescheduling engine 222 may be configured to make changes to an existing reservation by reconciling conflicts and minimizing schedule fragmentation.

In some embodiments, rescheduling engine 222 may be configured to work in conjunction with best appointment time engine 210. For example, rescheduling engine 222 may use the output generated by best appointment time engine 210 to identify the best time slots to which to move an appointment. In some embodiments, rescheduling engine 222 may also use the output generated by best appointment time engine 210 to identify an existing scheduled event that would be most amicable to a move.

Rescheduling engine 222 may use a deep neural network with logistic activation to generate a probability that a customer will accept an event reschedule request. For example, based on one or more of the rescheduled event date and time, time of the event reschedule request, and historical appointment data for the customer, rescheduling engine 222 can generate a probability that a given client will be amicable to a move.

In some embodiments, rescheduling engine 222 may be used in combination with best appointment time engine 210. For example, rescheduling engine 222 and schedule defragmentation service may work in conjunction to iterate all possible schedule modifications to choose the “best” schedule based on the constraints defined by the service provider. In some embodiments, rescheduling engine 222 may be configured or trained to optimize for revenue and utilization by taking available resources (e.g., constraints) into account. For example, rescheduling engine 222 may be trained to account for room availability, staff availability, equipment availability, or information associated with other services being performed at the same time, right before, or right after. Given those constraints, rescheduling engine 222 may be trained to generate all possible schedule permutations and choose the optimal schedule permutation for rescheduling the service appointment.

Staffing engine 224 may be configured to staff a schedule for events that are service provider agnostic based on a balance between availability and customer preference. Generally, a service provider agnostic event may refer to an event booking that did not specify a preference for a specific service provider (e.g., a customer booking a haircut without specifying the barber). In such situations, staffing engine 224 may be trained to recommend an optimal match making between the available service providers for the unspecified events by predicting customer preferences. Staffing engine 224 may further be trained to balance the workload between service providers, so that the workloads across service providers are similar.

In some embodiments, staffing engine 224 may utilize context based collaborative filtering to manage staffing. Context-based collaborative filtering may be used to predict a user's preference using historic staff schedules, as well as side information about staff, service being offered, scheduling constraints, time and day, client's information among others, to cope with sparsity and precision problem. Context-based collaborative filtering may also rely on side information to make a prediction when no direct interactions are available (cold start problem) and to improve overall predictions.

In some embodiments, staffing engine 224 may utilize user based collaborative filtering to infer or predict a user's rating of an item or event based on other similar users' ratings. For example, for each customer event (and service provider agnostic event), staffing engine 224 may identify k-similar customers based on their ratings/reviews. Staffing engine 224 may generate their average ratings for each available service provider. Staffing engine 224 may then assign the customer event to the provider with the highest rating.

In some embodiments, staffing engine 224 may utilize item based collaborative filtering. In some embodiments, item-based collaborative filtering may be based on user-item ranking. For example, a matrix would be generated based on staff-client interactions and the rating available for that interaction (reviews, tips, survey results, etc.). Staffing engine 224 may then perform matric factorization to predict missing information in the matrix to recommend staff substitution for a particular client-service combination.

In some embodiments, context can also be used to enhance the cold start predictions by utilizing user and items profiles/descriptions (features). For example, to address the cold start problem, staffing engine 224 may utilize available contextual information, such as information about staff, clients, and a time component to help predicting a ranking, even if there are no prior interactions available for a client or staff.

Pricing engine 226 may be configured to provide pricing recommendations of particular classes or services for a service provider. Such recommendations may be based on similar business and/or similar services and demand estimations. Pricing engine 226 may utilize a combination of autoencoders and k-means clustering to recommend pricing to a service provider. The autoencoder may be used to reduce the dimensionality of each business and its corresponding features. For example, to improve predictions and ensure that pricing engine 226 may be applicable to a greater population, pricing engine 226 may utilize autoencoders to extract underlying information in a condensed format by utilizing one or more deep learning techniques to compress the available features into a smaller, non-linear, subset of feature combinations. Pricing engine 226 may then perform k-means clustering to assign each business to a cluster. In this manner, pricing engine 226 may utilize k-means clustering for clustering groups of similar items (e.g., service providers, services, etc.) based on their features. Exemplary business features may include, but are not limited to, location, offered services, attendance, volume of purchases, client demographics, historic prices, subsequent demand for offered services, and the like. Based on the clusters, pricing engine 226 can recommend a pricing to the service provider.

In some embodiments, rather than use a k-means clustering approach, pricing engine 226 may use a k-nearest neighbors (KNN) algorithm following dimensionality reduction by the autoencoder. The KNN algorithm may be used to find the k-service providers that are most similar to the target business. Based on the identified k-service providers, pricing engine 226 can recommend pricing options to the target service provider.

Class schedule recommender 225 may be configured to generate a recommended class schedule for a service provider. For example, orchestrating a full schedule that involves multiple service providers, best capacity, time of day, day of the week, and/or recurrence that maximizes the expected attendance and revenue is a challenging task especially for service providers. Class schedule recommender 225 may simplify this process for service providers by generating recommendations as template schedules.

Class schedule recommender 225 may utilize a deep neural network regressor to predict customer demand. For example, a deep neural network (e.g., recurrent neural network) can be trained on a large set of businesses to predict the expected bi-weekly/month/quarterly attendance given historic attendance information, service provider features, class schedule, and nearby service provider features and schedules. In some embodiments, class schedule recommender 225 may be configured to estimate the expected attendance (and profit) given different possible schedules, based on the set of available resources and how they may be utilized by the service provider.

In some embodiments, class schedule recommender 225 may utilize a combination of autoencoders and k-nearest neighbors (KNN) techniques to reduce dimensionality of the data and generate recommendations. For example, given a large number of features for customer demand predictions, class schedule recommender 225 may reduce dimensionality of the data to help address the curse of dimensionality and accuracy of predictions. Using a specific example, class schedule recommender 225 may utilize an autoencoder that may be trained to extract underlying compressed non-linear feature combinations. KNN techniques may be used to identify similar businesses that can help contribute to expected demand predictions using, for example, historic information of, not just the business in question, but also similar businesses.

Additional service recommendation engine 228 may be configured to recommend services a service provider should offer based on, for example, national trends, regional trends, and the services currently being offered by the service provider. Additional service recommendation engine 228 may utilize an LSTM network to recommend services the service provider should offer. For example, for all service categories and subcategories offered across an industry in which a service provider operates, LSTM network may forecast trends on all scales (e.g., regional, county, country, urban vs. suburban, etc.). In some embodiments, LSTM network may further receive, as input, search records by customers in search engines and social media trends to better capture a prediction for existing services. Additional service recommendation engine 228 may recommend categories of services that have the highest growth potential and that are in line with the target service provider's offerings.

Revenue/demand engine 230 may be configured to generate a heat map based on a schedule provider's schedule or appointment book. Revenue/demand engine 230 may utilize a recurrent neural network (e.g., LSTM) to estimate revenue or demand based on the schedule provider's schedule or appointment book. For example, based on one or more of current and past bookings, seasonality trends, holiday fluctuations, monthly fluctuations, weekly fluctuations, daily fluctuations, and/or other information, recurrent neural network may learn long term dependencies and patterns based on current and past trends. Output from the RNN may be used to populate a calendar heatmap for a particular metric, such as revenue or demand.

In this manner, a service provider can easily identify which blocks of time generate the most income, what pairings of service and time generate the most income, the most in-demand times and services, and the like.

Class capacity manager 232 may be configured to manage the capacities of classes offered by a service provider. For example, given a class, a set of rooms, resources, and/or schedule information, class capacity manager 232 may be configured to recommend changes to a class schedule to produce more fully utilized rooms, equipment, classes, staff, etc. In operation, class capacity manager 232 may work in conjunction with revenue/demand engine 230. For example, class capacity manager 232 may be treated as a constraint satisfaction algorithm coupled with revenue/demand engine 230.

Class capacity manager 232 may generate all possible permutations of resource assignments (e. g. staff, rooms) to the existing schedule and predict associated demand. Class capacity manager 232 may select the permutation that maximizes staff work distribution, fairness, capacity and/or demand. Given the possible schedule instances based on resource availabilities, class capacity manager 232 may compute best resource allocations for all services.

Traveler engine 234 may be configured to recommend best appointment times based on appointment location and travel time, such that total travel time may be minimized when the schedule is realized. Some service providers may employ a travelling practitioner that travels to meet their clients throughout the day. As those skilled in the art understand, the time spent travelling is not profitable and therefore, it is beneficial to service providers to minimize the travel time of its travelling partitioners. Traveler engine 234 may provide such schedule optimization.

Traveler engine 234 may utilize deep reinforcement learning techniques (e.g., actor-critic paradigm) to optimize travel time. In some embodiments, traveler engine 234 may be similar to best appointment time engine 210. For example, traveler engine 234 may include the additional enhancement of taking travel time into account by including an additional set of features that may include location information of the provider and/or the service and associated travel time in order to minimize travel time and reduce scheduling gaps due to traveling to and from services. For each request (e.g., at each timestep), traveler engine 234 may be trained to recommend the best appointment times such that the final schedule has minimum travel time without sacrificing revenue. Traveler engine 234 may utilize a travel time prediction engine to predict the travel time between two locations at any given time (e.g., in the future). Such output may be used by traveler engine 234 when making a recommendation.

Schedule recommender 236 may be configured to recommend a personalized appointment plan for a customer based on the customer's goals or constraints. For example, based on customer-specific preferences, availability, skill level, history, final goal, and the like, schedule recommender 236 may be configured to recommend a personalized appointment plan using deep collaborative filtering. Deep collaborative filtering is an enhanced matrix factorization model that uses non-linear feature combinations to deliver enhanced performance. Such approach may take into account customer interaction data as well as individual contextual features. In some embodiments, schedule recommender 236 may utilize a recurrent neural network that may be added to the collaborative filtering techniques to capture customers' long and short-term preferences. Such network may use multiple layers to support extra non-linear operations.

Dynamic offer engine 238 may be configured to generate personalized offers for customers. Dynamic offer engine 238 may utilize a contextual bandit to generate the personalized dynamic offers. In some embodiments, the offers may be generated based on constraints set by the service provider. for example, dynamic offer engine 238 may be adjusted to generate offers to promote services, promote products, promote time spots, maximize a desired reward, and the like. At each timestep, dynamic offer engine 238 may select an offer for each customer such that the likelihood of accomplishing the desired goal is maximized. Contextual bandits can adapt to a continuously changing environment and customer behavior by constantly exploring alternative strategies and learning from the collected reward and the reward function. Dynamic offer engine 238 may utilize a custom reward function that can take various end goals into account. Exemplary end goals may include, but are not limited to, highest revenue, number of bookings, bookings for less desirable times, and the like.

Chat bot 240 may be configured to provide customer devices 102 with a customer facing scheduler. In some embodiments, chat bot 240 may interact with customer devices 102 via text message, phone, email, or as a virtual assistant through a website associated with a service provider system 106. Chat bot 240 may be configured to identify a desired booking time period for the customer, and may recommend appointment times for the customer to choose. In some embodiments, the appointment time options may be suggestions generated by best appointment times engine, such that the appointment times also optimize the service provider's schedule. In essence, chat bot 240 may automate the tasks typically associated with a front desk scheduling person.

Chat bot 240 may utilize one or more natural language processing techniques, such as speech-to-text algorithms to capture sentences during phone conversations and text-to-speech algorithms to read results back to the customer. In some embodiments, chat bot 240 may utilize one or more intent analysis algorithms to classify or determine the intent of a customer's message. In some embodiments, chat bot 240 may utilize one or more sentiment analysis algorithms to determine whether the customer is happy/unhappy with a particular feature. For example, chat bot 240 may utilize one or more sentiment analysis algorithms to determine when to escalate the customer's concerns to a human operator.

Virtual assistant 242 may be similar to chat bot 240. However, rather than virtual assistant 242 being a customer facing intelligent agent, virtual assistant 242 may be a service provider facing intelligent assistant. For example, when a customer calls a service provider to book an appointment, virtual assistant 242 may be configured to monitor the conversation such that virtual assistant 242 can surface relevant information to service provider staff in real-time. Using a more specific example, when a customer calls regarding a desired booking period, virtual assistant 242 may monitor the call to identify the desired booking period and may call one or more components of scheduling system 118 to identify open time slots and recommend the best time slots for the customer.

Virtual assistant 242 may use one or more natural language processing techniques, such as speech-to-text algorithms to capture customer sentences. In some embodiments, virtual assistant 242 may use one or more intent analysis algorithms, such as classification algorithms, to classify the customer's intent.

Orchestration engine 250 may be configured to determine which components of scheduling system 118 to trigger based on incoming event information. In some embodiments, the trigger may be a direct prompt for a service provider system 106. For example, an admin may request that orchestration engine 250 generate rebooking suggestions. In such example, orchestration engine 250 may trigger rebooking engine 218 to recommend the best time and day for a customer's next appointment. In some embodiments, the trigger may be a direct prompt from a customer device 102. For example, a customer, via an online portal, may request a rebooking process. In such example, orchestration engine 250 may trigger rebooking engine 218 to recommend the best time and day for a customer's next appointment. In some embodiments, the trigger may be an indirect trigger. For example, during checkout for a customer at the service provider's facility, orchestration engine 250 may receive an alert that a service provider initiated a checkout process for the customer. Based on that service provider's workflows, such action may cause orchestration engine 250 to trigger rebooking engine 218 to recommend the best time and day for a customer's next appointment.

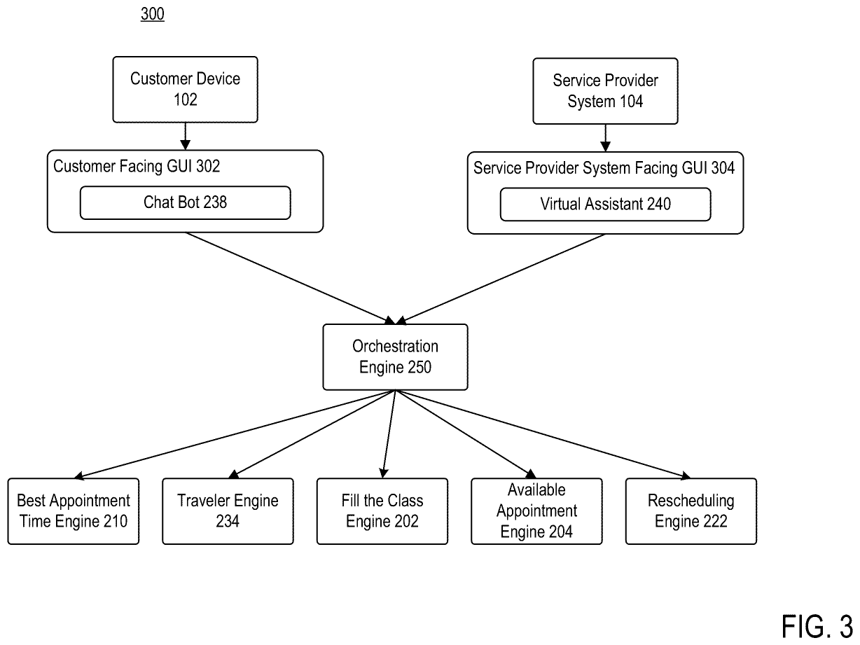

FIG. 3 is a block diagram 300 illustrating exemplary booking workflows, according to example embodiments.

As illustrated, a customer device 102 may initiate a first set of workflows. Customer device 102 may interact with scheduling system 118 by accessing application 110 executing on customer device 102. Customer device 102 may present to the customer a customer facing graphical user interface (GUI) 302. In some embodiments, via customer facing GUI 302, the customer may interact with chat bot 240. Through customer facing GUI 302, a customer may attempt to schedule an appointment with a service provider.

As shown, the request to schedule an appointment may be received at orchestration engine 250. Orchestration engine 250 may analyze the request to determine one or more components of scheduling system 118 to activate. For example, after determining that a booking workflow is relevant to the request, orchestration engine 250 may activate one or more of best appointment time engine 210, traveler engine 234, fill the class engine 202, available appointment engine 204, and rescheduling engine 222 to identify the best potential times for both the customer and the service provider.

In some embodiments, a service provider system 106 may initiate a second set of workflows. Service provider system 106 may interact with scheduling system 118 by accessing application 112 executing on service provider system 106. Service provider system 106 may present to the service provider a service provider facing GUI 304. In some embodiments, via service provider facing GUI 304, the service provider may interact with virtual assistant 242. Through service provider facing GUI 304, the service provider may attempt to schedule an appointment with a service provider on behalf of a customer.

As shown, similar to the first set of workflows, the request to schedule an appointment may be received at orchestration engine 250. Orchestration engine 250 may analyze the request to determine one or more components of scheduling system 118 to activate. For example, after determining that a booking workflow is relevant to the request, orchestration engine 250 may activate one or more of best appointment time engine 210, traveler engine 234, fill the class engine 202, available appointment engine 204, and rescheduling engine 222 to identify the best potential times for both the customer and the service provider.

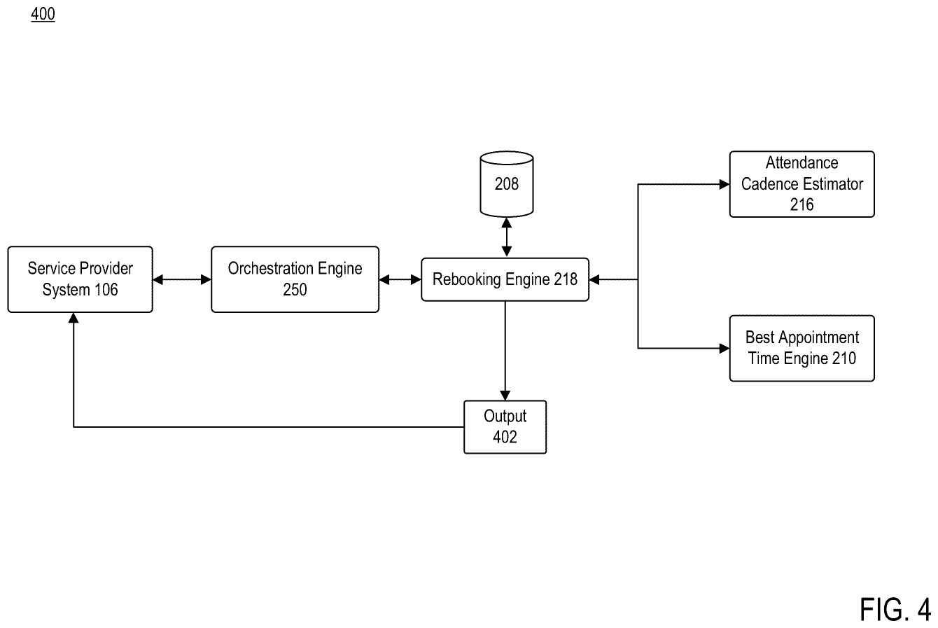

FIG. 4 is a block diagram 400 illustrating an example rebooking workflow, according to example embodiments.

As shown, in some embodiments, a service provider system 106 may initiate a rebooking workflow. In some embodiments, service provider system 106 can interact directly with scheduling system 118 via application 112. In some embodiments, service provider system 106 can interact with scheduling system 118 via virtual assistant 242. In some embodiments, a rebooking flow can be triggered using post visit text, email, or phone communication. In some embodiments, a rebooking workflow may be triggered using a client contacting service provider through a booking graphical user interface (e.g., website or application).

Orchestration engine 250 may receive the request initiated by service provider system 106. Orchestration engine 250 may analyze the request to determine which components of scheduling system 118 to activate. Responsive to determining the request is a rebooking request, orchestration engine 250 may activate one or more of rebooking engine 218, attendance cadence estimator 216, and best appointment time engine 210.

Rebooking engine 218 recommend the best time and day for a customer's next appointment. To determine the best time and day for the customer's next appointment, rebooking engine 218 may call attendance cadence estimator 216 and best appointment time engine 210. Attendance cadence estimator 216 may first predict the number of days between service events. For example, attendance cadence estimator 216 may predict the number of days between service events for the target customer. In some embodiments, attendance cadence estimator 216 may identify the service type and event slot associated with the rebooking request. Based on this information, attendance cadence estimator 216 may predict a probability of the customer booking each potential appointment or class spot. For example, attendance cadence estimator 216 may generate a list of potential appointment times, ranked based on the probability of the customer booking those potential appointment times.

Best appointment time engine 210 may determine the best potential appointment times for the service provider based on the best potential appointment times for the customer. For example, best appointment time engine 210 may analyzing the service provider's schedule to suggest the best potential appointment time for the service provider. Such process may attempt, for example, to reduce the number of small, unused gaps in the service provider's schedule.

Best appointment time engine 210 may utilize deep reinforcement learning techniques to recommend the best times for the potential appointment based on a balance between the best potential appointment times for the customer and the best potential appointment times for the service provider.

Rebooking engine 218 may then provide the list of best potential appointment times to service provider system 106 as output 402.

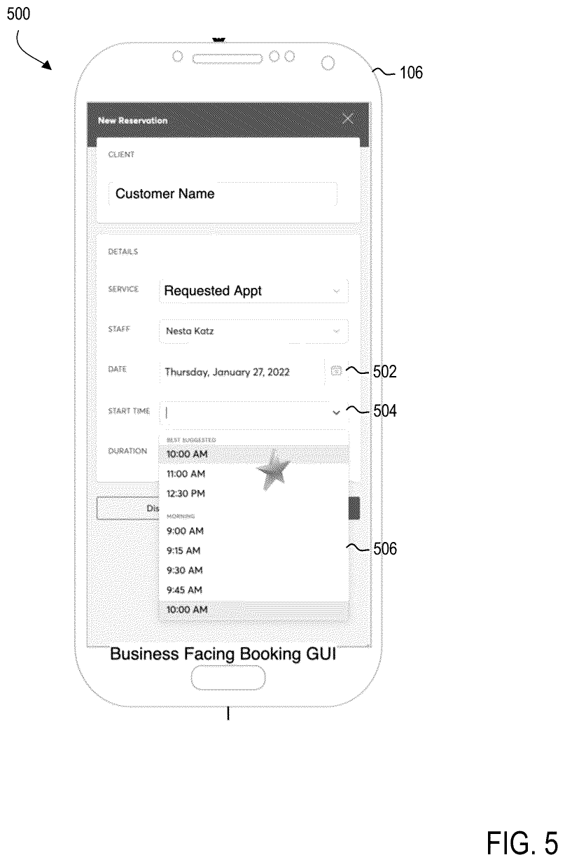

FIG. 5 illustrates an example graphical user interface (GUI) 500, according to example embodiments. As shown, GUI 500 may be displayed via service provider system 106. For example, a service provider may access functionality of scheduling system 118 via application 112 executing thereon.

GUI 500 may illustrate a “New Reservation” screen. In some embodiments, GUI 500 may be presented to the service provider during checkout of an existing customer that finished an appointment. As shown, GUI 500 may include a date field 502 and a start time field 504. Although only shown on start time field 504, when a service provider selects date field 502, a dropdown menu may appear with “Best Suggested” dates. Such Best Suggested dates may correspond to the best potential appointment dates generated by rebooking engine 218. Similarly, when a service provider selects start time field 504, a dropdown menu 506 may appear with “Best Suggested” times. Such Best Suggested times may correspond to the best potential appointment times generated by rebooking engine 218.

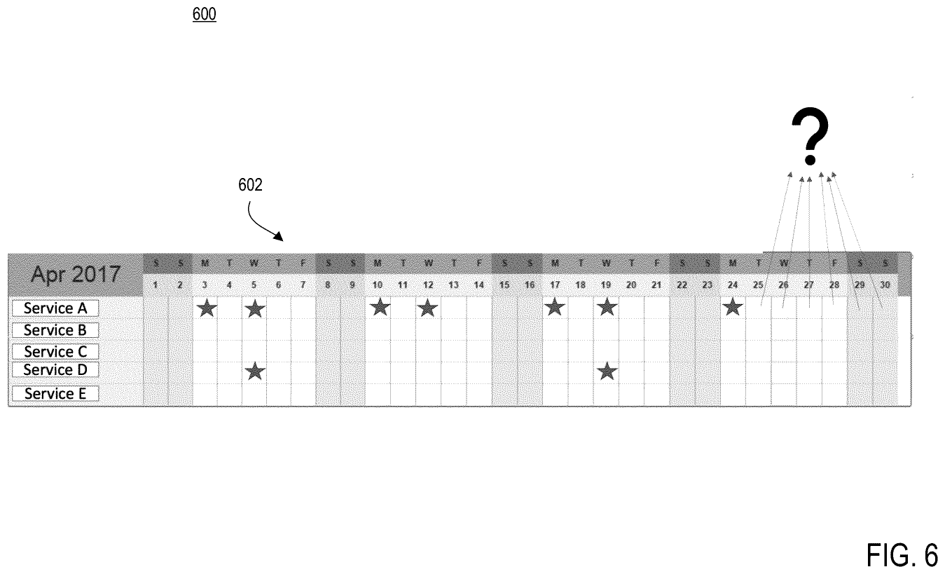

FIG. 6 is a block diagram 600 visually illustrating processes performed by attendance cadence estimator 216. As shown, block diagram 600 may include a chart 602. Chart 602 may have the days of the month of April 2017 across its x-axis and services offered by a service provider along its y-axis. Chart 602 may be representative of a customer's historical appointment information.

In operation, attendance cadence estimator 216 may analyze the historical appointment information to determine when the customer is expected to rebook an appointment. In some embodiments, attendance cadence estimator 216 may transform the data prior to input to the recurrent neural network (e.g., LSTM network). For example, attendance cadence estimator may generate an input, for Service A, that may include:
[2, 5, 2, 5, 2, 5,
0, 0, 0, 0, 0, 0,
1, 1, 1, 1, 1, 1,
0, 1, 0, 0, 1, 0,
1, 0, 0, 0, 1, 0]
   where the first row represents the delta of days between appointments, the second row represents a first feature of a corresponding appointment, the third row represents a second feature of a corresponding appointment, the fourth row represents a third feature of a corresponding appointment, and the fifth row represents a fourth feature of a corresponding appointment. Such input data may be provided to the recurrent neural network of attendance cadence estimator 216. Based on the input data, recurrent neural network may generate a list of float values that may represent the most likely predicted number of days between the last appointment and a future appointment to be made. Continuing with the example shown in FIG. 6, attendance cadence estimator 216 may determine that the customer is most likely to rebook two days after the last appointment. Accordingly, attendance cadence estimator 216 may determine that the next appointment will likely be on April 26.

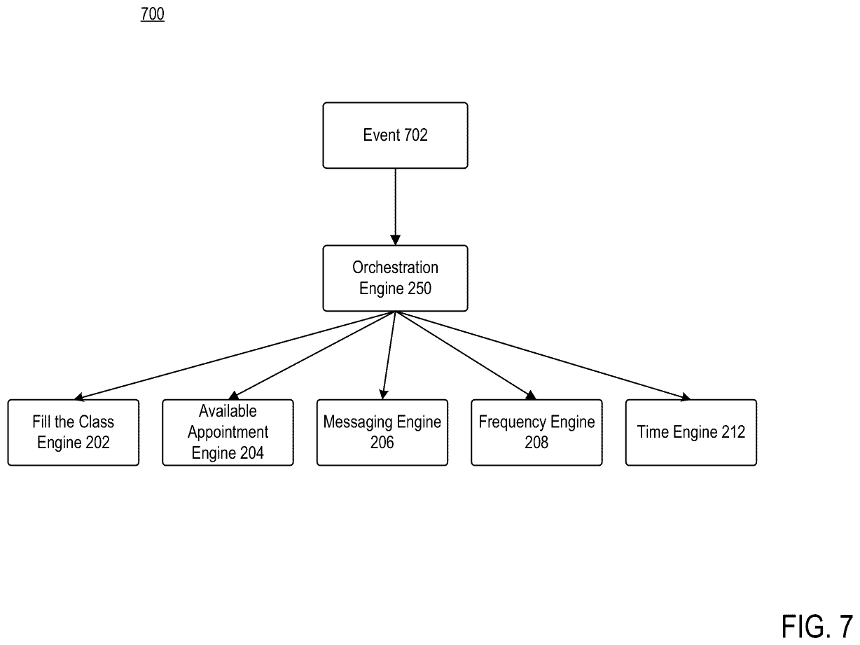

FIG. 7 is a block diagram 700 illustrating an example event fill workflow, according to example embodiments.

In some embodiments, event fill workflow may be triggered by event 702. In some embodiments, event 702 may be an automated event or trigger set by an administrator of a service provider system 106. In some embodiments, event 702 may be activated by a user, such as a service provider at service provider system 106. In either case, event 702 may trigger orchestration engine 250 to activate one or more components of scheduling system 118.

As shown, upon detecting event 702, orchestration engine 250 may activate one or more of fill the class engine 202, available appointment engine 204, messaging engine 206, frequency engine 208, and/or time engine 212. Fill the class engine 202 may identify an open spot in a class and may generate a list of customers most likely to be interested in the class at a given date or time. For example, for a particular class session with vacancies, fill the class engine 202 may analyze the class information and historical attendance information to generate a list of customers who would most likely be interested in the service at the given date/time.

In some embodiments, instead of fill the class engine 202 being activated, orchestration engine 250 may activate fill the available appointment engine 204. Fill the available appointment engine 204 may identify an empty time slot and, given all the resource constraints, determine a list of service-client pairs for the empty time slot.

In either case, fill the class engine 202 and fill the available appointment engine 204 may generate a list of customers for a given time slot and service.

Given the list of customers, messaging engine 206 may generate a customized communication to be sent to customers on the list of customers. The personalized message may be tailored to the specific service/class that is being filled and specific customer to which it is sent. Once the messages are generated, frequency engine 208 may determine an optimal communication frequency for each customer in the list of customers. Time engine 212 may then determine the best time to deliver each communication to each customer in accordance with the determined frequency.

In this manner, orchestration engine 250 may execute a workflow that fills an available appointment or class spot.

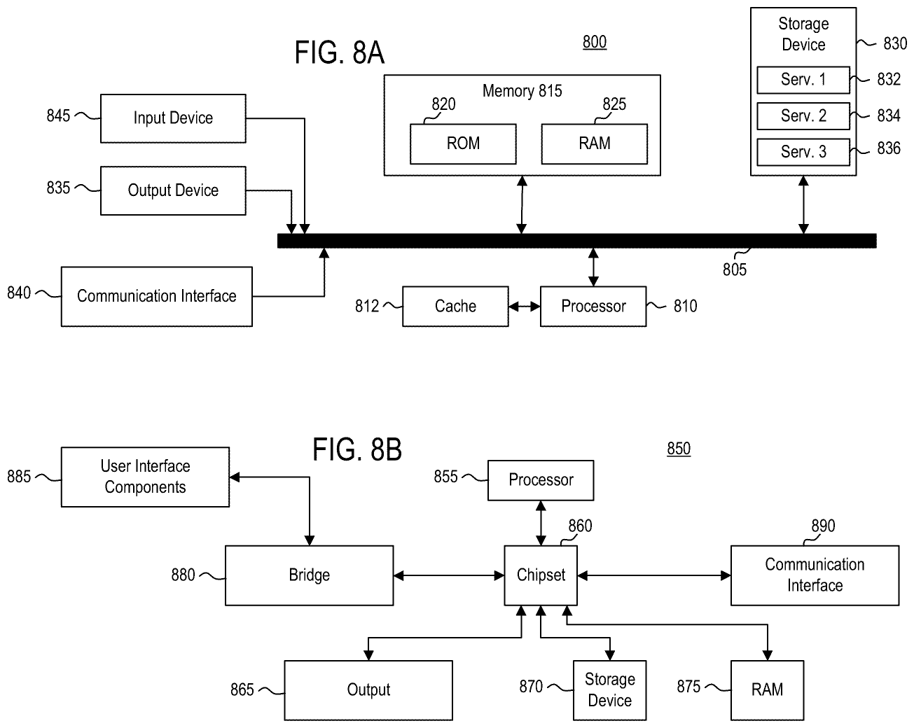

FIG. 8A illustrates an architecture of system bus computing system 800, according to example embodiments. One or more components of system 800 may be in electrical communication with each other using a bus 805. System 800 may include a processor (e.g., one or more CPUs, GPUs or other types of processors) 810 and a system bus 805 that couples various system components including the system memory 815, such as read only memory (ROM) 820 and random access memory (RAM) 825, to processor 810. System 800 can include a cache of high-speed memory connected directly with, in close proximity to, or integrated as part of processor 810. System 800 can copy data from memory 815 and/or storage device 830 to cache 812 for quick access by processor 810. In this way, cache 812 may provide a performance boost that avoids processor 810 delays while waiting for data. These and other modules can control or be configured to control processor 810 to perform various actions. Other system memory 815 may be available for use as well. Memory 815 may include multiple different types of memory with different performance characteristics. Processor 810 may be representative of a single processor or multiple processors. Processor 810 can include one or more of a general purpose processor or a hardware module or software module, such as service 1 832, service 2 834, and service 8 836 stored in storage device 830, configured to control processor 810, as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction with the system 800, an input device 845 which can be any number of input mechanisms, such as a microphone for speech, a touch-sensitive screen for gesture or graphical input, keyboard, mouse, motion input, speech and so forth. An output device 835 (e.g., a display) can also be one or more of a number of output mechanisms known to those of skill in the art. In some instances, multimodal systems can enable a user to provide multiple types of input to communicate with system 800. Communications interface 840 can generally govern and manage the user input and system output. There is no restriction on operating on any particular hardware arrangement and therefore the basic features here may easily be substituted for improved hardware or firmware arrangements as they are developed.

Storage device 830 may be a non-volatile memory and can be a hard disk or other types of computer readable media that can store data that are accessible by a computer, such as magnetic cassettes, flash memory cards, solid state memory devices, digital versatile disks, cartridges, random access memories (RAMs) 825, read only memory (ROM) 820, and hybrids thereof.

Storage device 830 can include services 832, 834, and 836 for controlling the processor 810. Other hardware or software modules are contemplated. Storage device 830 can be connected to system bus 805. In one aspect, a hardware module that performs a particular function can include the software component stored in a computer-readable medium in connection with the necessary hardware components, such as processor 810, bus 805, output device 835 (e.g., a display), and so forth, to carry out the function.

FIG. 8B illustrates a computer system 850 having a chipset architecture, according to example embodiments. Computer system 850 may be an example of computer hardware, software, and firmware that can be used to implement the disclosed technology. System 850 can include one or more processors 855, representative of any number of physically and/or logically distinct resources capable of executing software, firmware, and hardware configured to perform identified computations. One or more processors 855 can communicate with a chipset 860 that can control input to and output from one or more processors 855. In this example, chipset 860 outputs information to output 865, such as a display, and can read and write information to storage device 870, which can include magnetic media, and solid-state media, for example. Chipset 860 can also read data from and write data to storage device 875 (e.g., RAM). A bridge 880 for interfacing with a variety of user interface components 885 can be provided for interfacing with chipset 860. Such user interface components 885 can include a keyboard, a microphone, touch detection and processing circuitry, a pointing device, such as a mouse, and so on. In general, inputs to system 850 can come from any of a variety of sources, machine generated and/or human generated.

Chipset 860 can also interface with one or more communication interfaces 890 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by one or more processors 855 analyzing data stored in storage device 870 or 875. Further, the machine can receive inputs from a user through user interface components 885 and execute appropriate functions, such as browsing functions by interpreting these inputs using one or more processors 855.

It can be appreciated that example systems 800 and 850 can have more than one processor 810 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A system, comprising:
an orchestration engine configured to receive communications from a client device of a client and a provider device of a provider, the orchestration engine configured to execute workflows across a plurality of artificial intelligence engines, the plurality of artificial intelligence engines comprising:
a first set of artificial intelligence engines configured to work in conjunction to execute a booking workflow for processing a booking request received from the client device or the provider device,
a second set of artificial intelligence engines configured to work in conjunction to execute a rebooking workflow for process a rebooking request received upon detecting a first trigger event, and
a third set of artificial intelligence engines configured to work in conjunction to execute an event filling workflow to optimize a schedule of the provider.

2. The system of claim 1, wherein the first set of artificial intelligence engines comprises:
a first artificial intelligence engine comprising a deep reinforcement learning algorithm trained to identify a best appointment time for the client based on historical booking information of the client and an existing schedule of the provider.

3. The system of claim 2, wherein the first set of artificial intelligence engines comprises:
a second artificial intelligence engine comprising a deep reinforcement learning network configured to identify a best appointment time for the provider by reducing travel time to a client location.

4. The system of claim 2, wherein the first set of artificial intelligence engines comprises:
a second artificial intelligence engine comprising a deep reinforcement learning network configured to identify the best appointment time by minimizing fragmentation in the existing schedule of the provider.

5. The system of claim 2, wherein the first set of artificial intelligence engines comprises:
a second artificial intelligence engine comprising a neural network trained to move an existing reservation by reconciling conflicts with the existing schedule of the provider and minimizing schedule fragmentation.

6. The system of claim 1, wherein the first set of artificial intelligence engines comprises:
a first artificial intelligence engine comprising a recurrent neural network trained to identify a list of clients for an open appointment slot based on constraints of a service being offered at the open appointment slot and historical booking information associated with the list of clients.

7. The system of claim 1, wherein the second set of artificial intelligence engines comprises:
a first artificial intelligence engine comprising a recurrent neural network trained to predict a number of days between a current appointment for the client and a future appointment for the client based on service type and time slot; and
a second artificial intelligence network comprising a deep reinforcement learning network trained to identify a set of best appointment times for the provider based on the predicted number of days.

8. The system of claim 1, wherein the third set of artificial intelligence engines comprises:
a first artificial intelligence engine comprising a recurrent neural network trained to generate a list of clients most likely to book an appointment at a given time slot;
a second artificial intelligence agent comprising a generative adversarial network coupled with a deep learning keyword extractor trained to generate a customized communication for each client in the list of clients;
a third artificial intelligence agent contextual bandit algorithms configured to determine, for each client in the list of clients, a frequency at which to send the customized communication; and
a fourth artificial intelligence engine comprising an online machine learning model trained to identify, for each client in the list of clients, a best time of day to deliver the customized communication to the client based on a context of the customized communication.

9. A method, comprising:
receiving, by a computing system, a request to schedule an appointment for a client, wherein the appointment is for a service with a service provider;
generating, by a deep reinforcement learning network of the computing system, a set of recommend times for the service, wherein set of recommend times minimizes fragmentation in a schedule of the service provider;
causing, by the computing system, the set of recommended times to be displayed to the client; and
responsive to receiving a selection from the client, generating, by the computing system, an appointment event for the client.

10. The method of claim 9, further comprising:
detecting, by a computing system, a trigger event, wherein the trigger event indicates that the appointment event for the client is over; and
responsive to the detecting, executing, by the computing system, a rebooking workflow to book a future appointment event for the client by:
predicting, by a recurrent neural network, a number of days between the appointment event for the client and the future appointment event based on service type and historical booking information associated with the client, and
based on the predicted number of days, generating, by the deep reinforcement learning network, a set of best appointment times for the future appointment event, wherein the set of best appointment times minimizes fragmentation in a schedule of the service provider.

11. The method of claim 10, further comprising:
causing, by the computing system, the set of best appointment times to be displayed to the client; and
responsive to receiving a further selection from the client, generating, by the computing system, a new appointment event for the client.

12. The method of claim 9, further comprising:
receiving, by the computing system from the client, a further request to move the appointment event; and
responsive to the further request, identifying, by the computing system, a new proposed appointment event by reconciling conflicts with existing appointments in the schedule and further minimizing fragmentation of the schedule.

13. The method of claim 9, further comprising:
receiving, by the computing system, a second request to create a second appointment event from a provider computing system; and
based on the second request, identifying, a recurrent neural network, a list of clients for an open appointment slot based on constraints of a service being offered at the open appointment slot and historical booking information associated with the list of clients.

14. The method of claim 13, further comprising:
recommending, by a second deep reinforcement learning network, the open appointment slot be moved to a new appointment slot responsive to determining that the new appointment slot reduces provider travel time to a client location.

15. A method, comprising:
detecting, by a computing system, a trigger event to execute a workflow to fill an open appointment with a provider;
responsive to detecting the trigger event, generating, by a recurrent neural network, a list of clients for the open appointment based on constraints of a service being offered at the open appointment and historical booking information associated with the list of clients;
for each client in the list of clients, generating, using a generative adversarial network, a customized communication;
determining, by the computing system using contextual bandwidth algorithms, a frequency at which to send each customized communication;
identifying, by an online machine learning model of the computing system, a best time of day to deliver the customized communication to each client in the list of clients based on a context of the customized communication; and
sending, by the computing system, each customized communication.

16. The method of claim 15, further comprising:
receiving, by the computing system, an indication that a first client in the list of clients has taken the open appointment; and
responsive to the indication, generating, by the computing system, an appointment event for the first client.

17. The method of claim 16, further comprising:
responsive to generating the appointment event, analyzing, by a deep reinforcement learning network of the computing system, a schedule of the provider to determine whether any existing appointments can be moved to minimize fragmentation in the schedule.

18. The method of claim 16, further comprising:
receiving, by the computing system from the first client, a further request to move the appointment event; and
responsive to the further request, identifying, by the computing system, a new proposed appointment event by reconciling conflicts with existing appointments in a schedule of the provider.

19. The method of claim 16, further comprising:
detecting, by the computing system, a second trigger event, wherein the second trigger event indicates that the appointment event for the first client is over; and
responsive to the detecting, executing, by the computing system, a rebooking workflow to book a future appointment event for the client by:
predicting, by a second recurrent neural network, a number of days between the appointment event for the client and the future appointment event based on service type and historical booking information associated with the client, and
based on the predicted number of days, generating, by a deep reinforcement learning network, a set of best appointment times for the future appointment event, wherein the set of best appointment times minimizes fragmentation in a schedule of the provider.

20. The method of claim 19, further comprising:
causing, by the computing system, the set of best appointment times to be displayed to the first client; and
responsive to receiving a further selection from the first client, generating, by the computing system, a new appointment event for the first client.
